(19) United States
(12) Patent Application Publication
(10) Pub. No.: US 2006/0141968 A1
(43) Pub. Date: Jun. 29, 2006

(54) Wireless communication apparatus and wireless communication board

(75) Inventor: Toshiyuki Masaki, Fukaya-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/293,063

(22) Filed: Dec. 2, 2005

(30) Foreign Application Priority Data
Dec. 28, 2004 (JP) P2004-380379

(51) Int. Cl. H04B 1/06; H04B 1/38

(52) U.S. Cl. 455/272; 455/73

(57) ABSTRACT

A wireless communication apparatus including: a plurality of transmitting/receiving sections which cooperate with each other to perform a wireless communication by the same communication method; a power supplying section which supplies power to the plurality of transmitting/receiving sections; and a switching section which switches between a mode in which only part of the plurality of transmitting/receiving sections is supplied with power from the power supplying section and the wireless communication is performed by the part of the plurality of transmitting/receiving sections and another mode depending on whether a prescribed condition is satisfied.

### CROSS-REFERENCE TO RELATED APPLICATIONS

This application is based upon and claims the benefit of priority from the prior Japanese Patent Application No. 2004-380379, filed on Dec. 28, 2004; the entire contents of which are incorporated herein by reference.

### BACKGROUND

1. Field

The present invention relates to a wireless communication apparatus and a wireless communication board.

2. Description of the Related Art

In recent years, to enable transmission and reception of a large amount of data such as video data, the transmission rate of wireless communications has been increased. For example, in the wireless LAN (local area network) technology, attention is now paid to the MIMO (multiple input multiple output) communication in which the communication capacity is increased by transmitting and receiving data using plural transmitting/receiving sections.

In the MIMO communication, the power consumption is high because of the use of plural transmitting/receiving sections. Therefore, techniques for reducing the power consumption have been developed (e.g., JP-A-2004-129066) JP-A-2004-129066 proposes a technique in which the power consumption is reduced by sharing a frequency converting section among the transmitting/receiving sections.

### BRIEF DESCRIPTION OF THE DRAWINGS

FIG. 1 is a conceptual diagram showing the configuration of a communication system including a notebook PC according to an embodiment of the invention;

FIG. 2 shows implementation examples of antennas and a Mini PCI card which performs a wireless communication in the notebook PC;

FIG. 3 is a block diagram showing the configuration of the notebook PC;

FIG. 4 shows an exemplary communication mode setting picture through which to set a communication mode in the notebook PC;

FIG. 5 shows an exemplary setting picture through which to set a data size threshold value for communication mode switching in the notebook PC;

FIG. 6 is a flowchart of a process that is executed by the notebook PC in determining a communication method;

FIG. 7 shows an exemplary setting picture through which to set connection apparatus to enable determination of a communication method in a notebook PC according to a modification of the invention;

FIG. 8 is a flowchart of a process that is executed by a notebook PC according to another modification of the invention in changing a communication method; and

FIG. 9 is a block diagram showing the configuration of a notebook PC according to a further modification of the invention.

### DETAILED DESCRIPTION

A wireless communication apparatus and a wireless communication board according to embodiments of the invention will be hereinafter described with reference to the drawings.

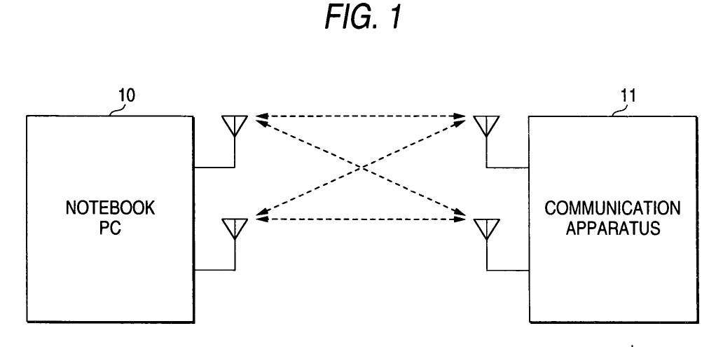

FIG. 1 is a conceptual diagram showing the configuration of a communication system including a notebook PC as a wireless communication apparatus according to an embodiment of the invention. This communication system includes a notebook PC 10 and a communication apparatus 11 each of which has two antennas capable of wireless LAN transmission and reception. Each of the notebook PC 10 and the communication apparatus 11 transmits and receives data using the two antennas. The communication apparatus 11 may be any apparatus such as a TV receiver incorporating a TV tuner, a notebook PC, or a printer as long as it can perform wireless LAN transmission and reception.

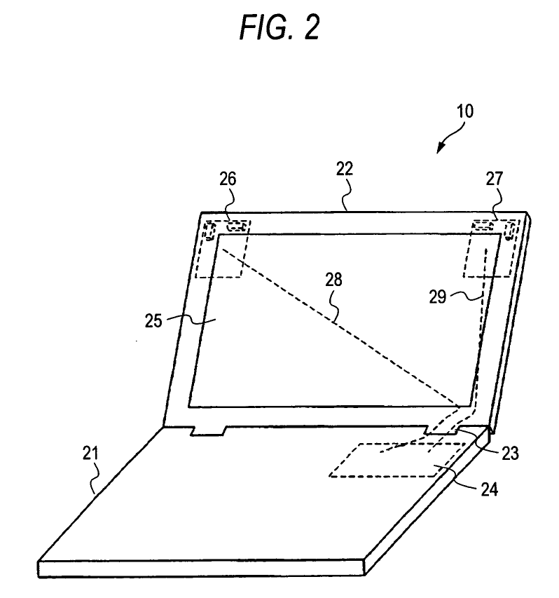

FIG. 2 shows an implementation example of the antennas and a Mini PCI card which performs a wireless communication. The notebook PC 10 includes a computer main body 21 and a display body 22 which are joined to each other rotatably via hinges 23.

The computer main body 21 is equipped with a computer board (not shown) incorporating a CPU, a memory, etc., and a Mini PCI card 24 (wireless communication board) incorporating a wireless communication module. The display body 22 is equipped with a display unit 25 and antennas 26 and 27. The antennas 26 and 27 are disposed on the free-end side that is opposite to the hinges 23 so as to be spaced from each other in the right-left direction. The antennas 26 and 27 are connected to the Mini PCI card 24 incorporated in the computer main body 21 via respective coaxial cables 28 and 29. While the notebook PC 23 is used, the display body 22 is opened relative to the computer main body 21 and hence the thus-arranged antennas 26 and 27 come to be located at such positions as to provide good radiation characteristics.

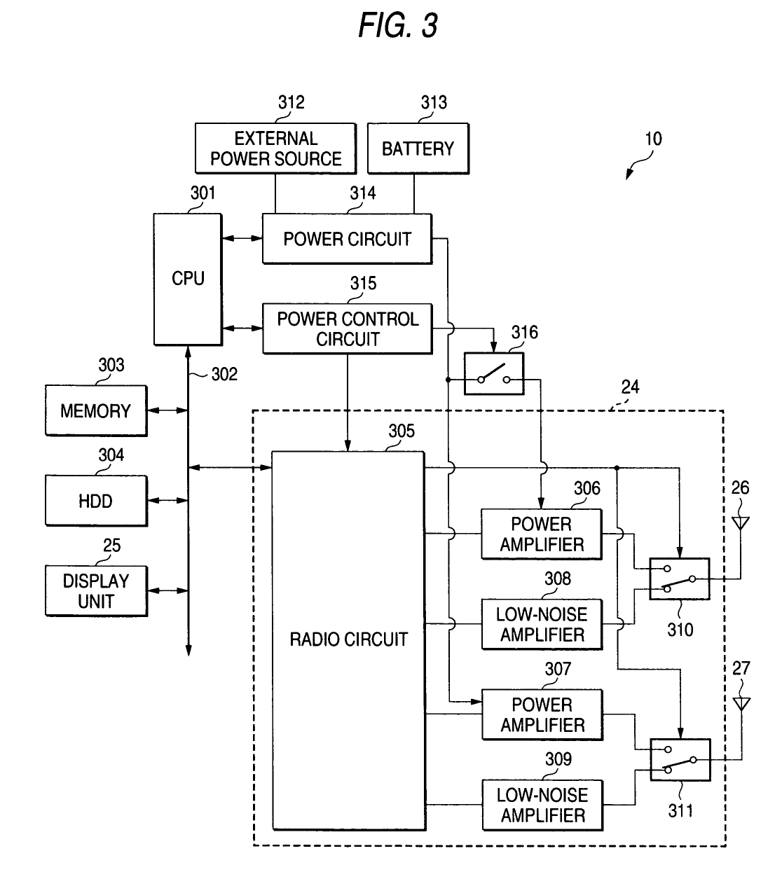

FIG. 3 is a block diagram showing the configuration of the notebook PC 10. The notebook PC 10 includes a CPU (central processing unit) 301, a memory 303 which is connected to the CPU 301 via a bus 302, an HDD (hard disk drive) 304, the display unit 25, a radio circuit 305 which is also connected to the bus 320 and controls a wireless communication, power amplifiers (hereinafter abbreviated as PAs) 306 and 307 for amplifying a transmission signal that is output from the radio circuit 305, the antennas 26 and 27, low-noise amplifiers (hereinafter abbreviated as LNAs) 308 and 309 for amplifying a reception signal that is received by the antennas 26 and 27, switches 310 and 311 for switching between reception and transmission, a power circuit 314 for supplying power (originating from an external power source 312 or a battery 313) to the PAs 306 and 307, a power control circuit 352 for switching between a MIMO communication mode and an existing communication mode (hereinafter referred to as “ordinary communication mode”) using a single-system transmitting/receiving section, and a switch 316 for switching between a state of supplying power to the PA 306 and a state of not supplying power to it. Among the above components, the radio circuit 305, PAs 306 and 307, LNAs 308 and 309, and the switches 310 and 311 are incorporated in the Mini PCI card 24 shown in FIG. 2.

The CPU 301, which is a processor for controlling the entire operation of the notebook PC 10 in a unified manner, runs a program having a function of switching the communication mode in accordance with whether power is supplied from the external power source 312 or the battery 313. The memory 303 is referred to while the above program is run. The HDD 304, which is a high-capacity storage device, store data to be transmitted to the communication apparatus 11 and other information.

Controlled by the CPU 301, the radio circuit 305 sets a MAC (media access control) address, an IP (Internet protocol) address, etc., according to a communication protocol. Further, the radio circuit 305 performs communication controls of the MIMO communication mode and the ordinary communication mode using only a single-system transmitting/receiving section (the transmitting/receiving section includes a PA, an LNA, an antenna, and a switch) and communication controls of IEEE802.11a, IEEE802.11b, IEEE802.11g, etc.

One end of the PA 306 is connected to the radio circuit 305 and the other end is connected to the antenna 26 via the switch 310, and one end of the PA 307 is connected to the radio circuit 305 and the other end is connected to the antenna 27 via the switch 311. The PAs 306 and 307 play a role of amplifying transmission signals to be transmitted from the antennas 26 and 27, respectively, to a prescribed output power level (e.g., 15 dBm).

One end of the LNA 308 is connected to the antenna 26 via the switch 310 and the other end is connected to the radio circuit 305, and one end of the LNA 309 is connected to the antenna 27 via the switch 311 and the other end is connected to the radio circuit 305. The LNAs 308 and 309 play a role of amplifying reception signals that are received by the antennas 26 and 27 and are to be output to the radio circuit 305, respectively. Amplified reception signals have features of low noise and small distortion.

The switches 310 and 311 are switches for switching between transmission and reception. Controlled by the radio circuit 305, the switch 310 makes switching to the PA 306 side when data are to be transmitted from the antenna 26, and makes switching to the LNA 308 side when data are to be received from the antenna 26. Likewise, controlled by the radio circuit 305, the switch 311 makes switching to the PA 307 side when data are to be transmitted from the antenna 27, and makes switching to the LNA 309 side when data are to be received from the antenna 27.

Controlled by the CPU 301, the power circuit 314 plays a role of switching the source of power to the external power source 312 or the battery 313, converting the voltage to a proper value, and supplying power to the PAs 306 and 307. The switch 316 is inserted in the path from the power circuit 314 to the PA 306, which makes it possible to switch between a state of supplying power to the PA 306 and a state of not supplying power to it.

Controller by the CPU 301, the power control circuit 315 switches the communication mode to the MIMO communication mode or the ordinary communication mode. More specifically, the power control circuit 315 switches between opening and closing of the switch 316 and thereby switches between the state that power is supplied from the power circuit 314 to the PA 306 and the state that power is not. Further, the power control circuit 315 switches the communication mode to the MIMO communication mode or the ordinary wireless LAN communication mode by sending a control signal to the radio circuit 305.

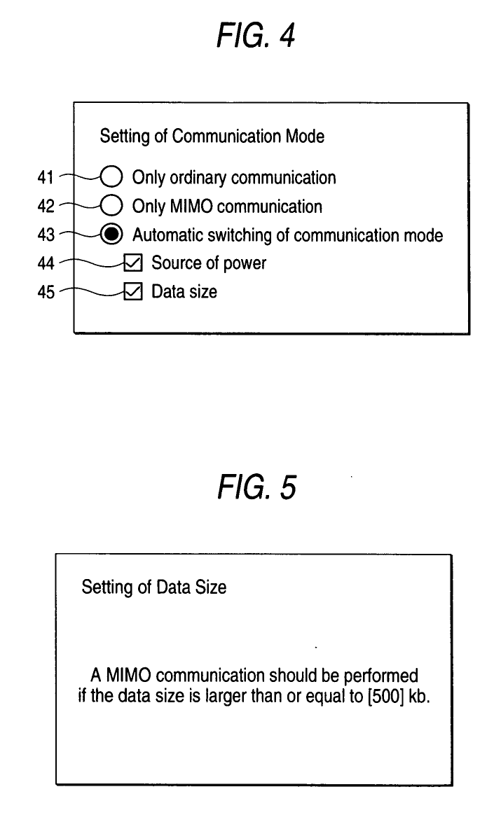

Next, a description will be made of a process for determining a communication method. A user makes communication-mode-related settings in advance. FIG. 4 shows an exemplary communication mode setting picture through which the user is to set a communication mode. Using the setting picture of FIG. 4, the user can select one of the ordinary communication mode (button 41), the MIMO communication mode (button 42), and automatic switching between them (button 43).

When the button 43 is selected (i.e., automatic switching), it is possible to set, using check boxes 44 and 45, an item in accordance with which the communication mode should be switched. When the check box 44 is checked, the switching between the MIMO communication mode and the ordinary communication mode is made in accordance with the source of power. More specifically, when the source of power of the notebook PC 10 is the battery 313, the ordinary communication mode is employed for power saving.

When the check box 45 is checked, switching between the switching between the MIMO communication mode and the ordinary communication mode is made in accordance with the data size. A threshold value for the switching is set by the user. FIG. 5 shows a setting picture through which to set a threshold value for the switching between the switching between the MIMO communication mode and the ordinary communication mode. In the setting picture of FIG. 5, the user inputs an arbitrary number to the box. Switching is made to the MIMO communication mode when the file size is larger than or equal to the thus-input setting number (in the example of FIG. 5, 500 kB), and to the ordinary communication mode when the file size is smaller than that. Settings that have been made through the setting pictures of FIGS. 4 and 5 are stored in the memory 303.

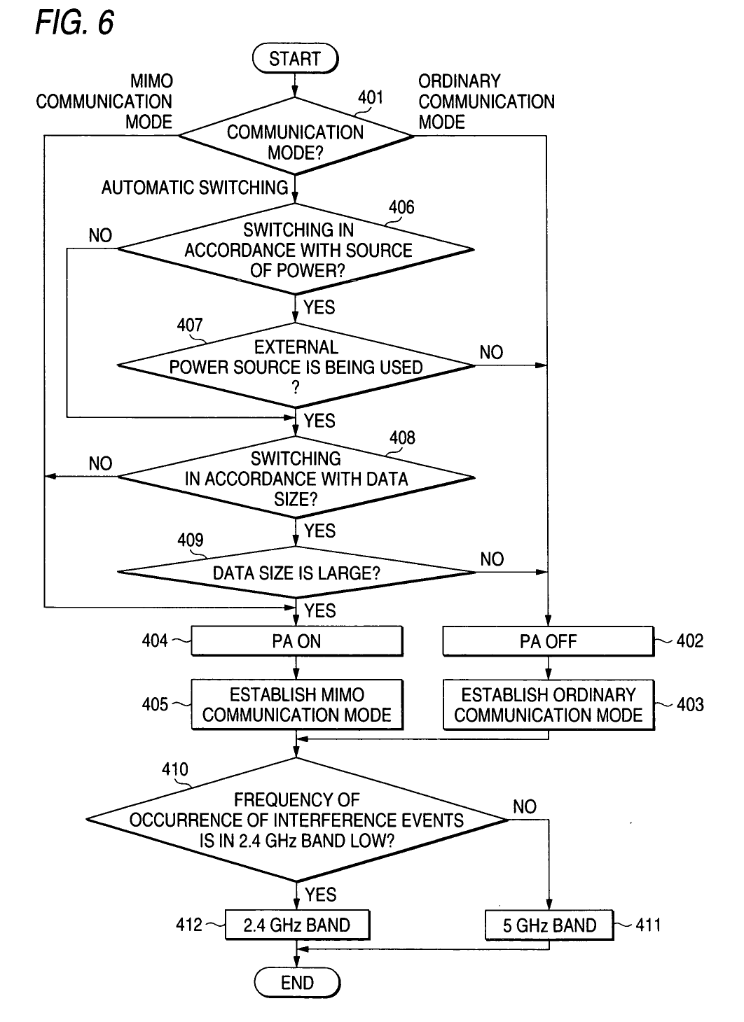

A communication method is determined in accordance with settings made by the user through the setting pictures of FIGS. 4 and 5. FIG. 6 is a flowchart of a process that is executed by the notebook PC 10 in determining a communication method of a communication to be performed with the communication apparatus 11.

First, the CPU 301 refers to a communication mode setting of a user that is stored in the memory 303 (step 401). If the user has made a setting that only the ordinary communication mode should be employed (“ordinary communication mode” at step 401), the CPU 301 causes the power control circuit 315 to open the switch 316 and thereby interrupts the supply of power from the power circuit 314 to the PA306 (step 402). Further, the CPU 301 sends the radio circuit 305 a control signal to the effect that a communication should be performed in the ordinary communication mode (step 403).

When the user has made a setting that only the MIMO communication mode should be employed (“MIMO communication mode” at step 401), the CPU 301 causes the power control circuit 315 to close the switch 316 and thereby permits the supply of power from the power circuit 315 to the PA307 (step 404). Further, the CPU 301 sends the radio circuit 305 a control signal to the effect that a communication should be performed in the MIMO communication mode (step 405).

When the user has made a setting that automatic switching should be made between the MIMO communication mode and the ordinary communication mode (“automatic switching” at step 401), the CPU 301 judges, by referring to the corresponding user setting stored in the memory 303, whether or not the user has made a setting that the communication mode should be switched in accordance with the source of power (step 406). More specifically, the CPU 301 judges whether or not the user checked the check box 44 after selecting the button 43 in the setting picture of FIG. 4.

When the user has made a setting that the communication mode should be switched in accordance with the source of power (“yes” at step 406), the CPU 301 judges whether the power circuit 314 is being supplied with power from the external power source 312 or the battery 313 (step 407). When the power circuit 314 is being supplied with power from the battery 313 (“no” at step 407), the CPU 301 judges that the power consumption should be reduced and hence effects a communication in the ordinary communication mode which is featured by a low power consumption (steps 402 and 403).

When the power circuit 314 is being supplied with power from the external power source 312 (“yes” at step 407) or the user has not made a setting that the communication mode should be switched in accordance with the source of power (“no” at step 406), the CPU 301 judges, by referring to the memory 303, whether or not the user has made a setting that the communication mode should be switched in accordance with the data size (step 408). More specifically, the CPU 301 judges whether or not the user checked the check box 45 after selecting the button 43 in the setting picture of FIG. 4.

When the user has made a setting that the communication mode should be switched in accordance with the data size (“yes” at step 408), the CPU 301 judges whether or not the data size of a file to be transmitted or received is larger than or equal to a threshold value that was set by the user in the setting picture of FIG. 5 (step 409). The threshold value that was set by the user is stored in the memory 303. When the data size is smaller than the threshold value (“no” at step 409), the CPU 301 judges that a high-capacity communication is not necessary and hence effects a communication in the ordinary communication mode (steps 402 and 403).

When the data size of the file to be transmitted or received is larger than or equal to the threshold value (“yes” at step 409) or the user has not made a setting that the communication mode should be switched in accordance with the data size (“no” at step 408), the CPU 301 effects a communication in the MIMO communication mode (steps 404 and 405).

After judging whether a communication should be performed in the MIMO communication mode or the ordinary communication mode (step 403 or 405), the CPU 301 determines a frequency to be used in the communication. More specifically, the CPU 301 checks the frequency of occurrence of radio interference events in the 2.4 GHz band (step 410). The frequency of occurrence of radio interference events can be judged by, for example, checking the number of nearby clients who are performing communications in the 2.4 GHz band. If, for example, the number of nearby clients who are performing communications in the 2.4 GHz band is larger than or equal to a prescribed number, the CPU 301 judges that the frequency of occurrence of radio interference events is high (“no” at step 410) and effects a communication in the 5 GHz band (IEEE802.11a; step 411).

If judging that the frequency of occurrence of radio interference events is low (“yes” at step 410), the CPU 301 effects a communication in the 2.4 GHz band (IEEE802.11g; step 412).

After determining a communication method in the above-described manner, the notebook PC 10 communicates with the communication apparatus 11 by the thus-determined communication method.

As described above, in this embodiment, whether to reduce the power consumption is judged on the basis of a user's direct setting of a communication mode or whether power is supplied from the external power source 312 or the battery 313. On the basis of a result of this judgment, the ordinary communication mode in which only the single-system transmitting/receiving section (i.e., the PA 307, antenna 27, and LNA 309) is used or the MIMO communication mode in which plural antennas are used and hence a high-capacity communication is possible is selected. This makes it possible to reduce the power consumption in accordance with the situation. In particular, a MIMO communication can be avoided during a battery drive, which enables long-time use of the battery 313.

In this embodiment, selection between a MIMO communication and an ordinary communication can be made in accordance with a user's communication mode setting. In the case of automatic switching, a setting can be made as to whether this switching should be made in accordance with the source of power or the data size. As a result, whether the power consumption should be reduced or a method for attaining a large communication capacity should be sought can be determined according to an intention of a user.

In this embodiment, the communication mode to be employed is switched in accordance with the data size of a file to be communicated. In general, the load on the CPU 301 is heavy when a high-capacity communication such as a MIMO communication is performed. In contrast, according to the embodiment, the CPU 301 can be prevented from bearing an unduly heavy load because a high-capacity communication is not performed when the data size is small as exemplified by a case of text data.

In this embodiment, the frequency band used is determined in accordance with the radio interference status, which makes it possible to avoid being subjected to undue radio interference.

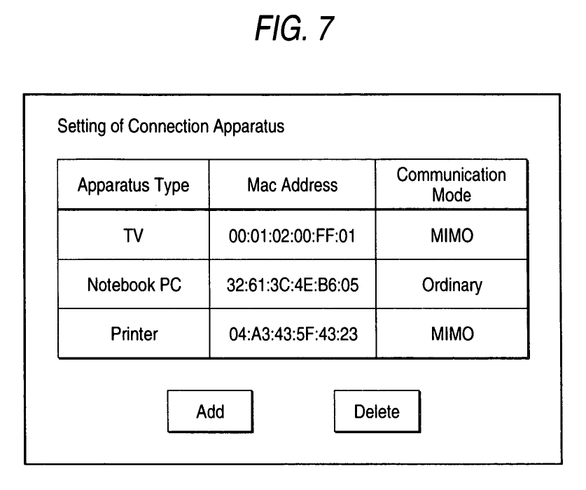

In this embodiment, a communication mode is determined in accordance with a user's communication mode setting, a source of power, and a data size. However, the invention is not limited to such a case. For example, a communication mode may be determined in accordance with a type of the communication apparatus 11. FIG. 7 shows a setting picture through which to set connection apparatus 11. The setting picture of FIG. 7 makes it possible to set apparatus types (in the example of FIG. 7, a TV receiver, a notebook PC, and a printer) of connection apparatus 11, their MAC addresses, and communication modes to be used (the MIMO communication mode for the TV receiver and the printer and the ordinary communication mode for the notebook PC). If the notebook PC 10 is configured so as to be able to determine a communication mode in accordance with a type of a connection apparatus 11 on the basis settings thus made by a user, the MIMO communication mode can be employed forcibly for a communication with a TV receiver or the like which is high in realtimeness.

Another modification is as follows. While a MIMO communication is performed with driving by the battery 313, the power circuit 314 and the CPU 301 check, always or regularly, the remaining life of the battery 313. When the remaining life of the battery 313 has become shorter than a prescribed value (e.g., a half of the original life), switching is made automatically to the ordinary communication mode.

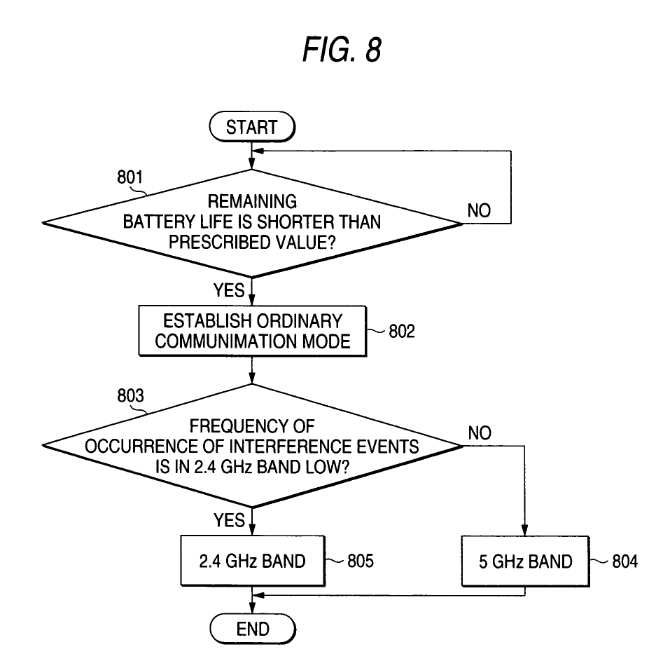

FIG. 8 is a flowchart of a process in which the communication mode is switched in accordance with the remaining battery life. It is assumed that at the start of this process the notebook PC 10 is operating on power that is supplied from the battery 313 and is performing a MIMO communication with the communication apparatus 11. During the MIMO communication, the power circuit 314 and the CPU 301 monitor the remaining life of the battery 313 (step 801). When the remaining life is longer than or equal to a prescribed value (e.g., a half of the original life; “no” at step 801), the MIMO communication is continued. When the remaining life is shorter than the prescribed value (“yes” at step 801), switching is made to the ordinary communication mode (step 802). In this case, a frequency band to be used is determined in the same manner as at steps 410-412 in FIG. 6. More specifically, the CPU 301 checks the frequency of occurrence of radio interference events in the 2.4 GHz band (step 803). If the frequency of occurrence of radio interference events is high (“no” at step 803), the CPU 301 effects a communication in the 5 GHz band (IEEE802.11a; step 804). If the frequency of occurrence of radio interference events is low (“yes” at step 803), the CPU 301 effects a communication in the 2.4 GHz band (IEEE802.11g; step 805).

With the above process, a MIMO communication can be performed in the case where, for example, the driving by the battery 313 can continue only for a short time. Where the battery 313 can be used for a long time, the time during which the battery 313 is usable can be elongated by switching to the ordinary communication mode halfway which is featured by a low power consumption. This modification may be such that a user is allowed to set, in terms of a remaining life (percentage), when to switch from the MIMO communication mode to the ordinary communication mode.

Although in the above embodiment the two systems of transmitting/receiving sections are provided, more systems of transmitting/receiving sections may be provided. In this case, a control can be performed in many stages. For example, where three systems of transmitting/receiving sections are provided, the number of systems used can be determined in accordance with a power consumption and a necessary communication capacity by performing a control in three stages (a single system, two systems, and three systems).

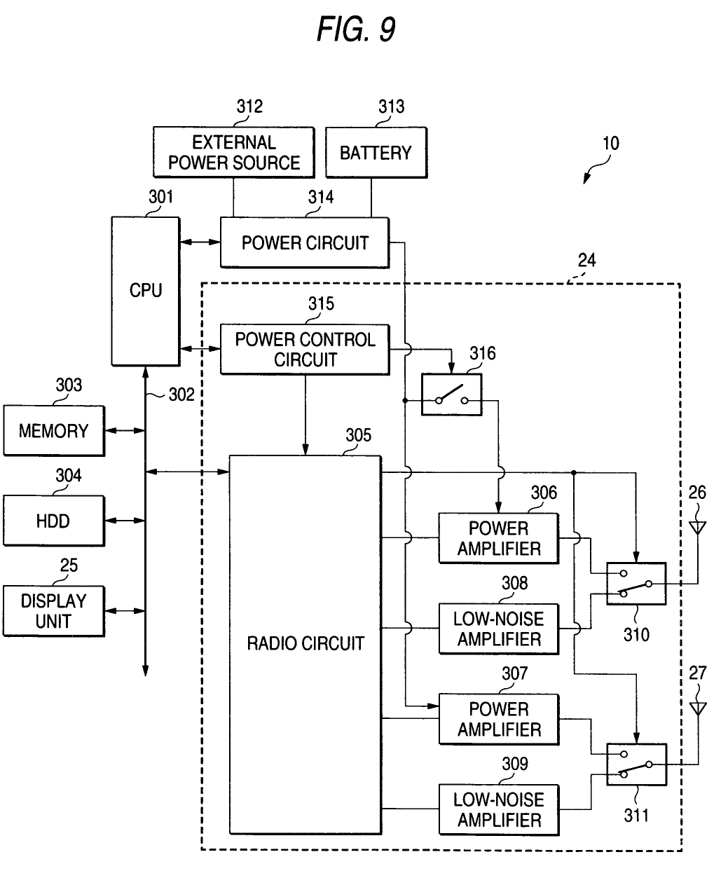

Although in the above embodiment the Mini PCI card 24 incorporates the radio circuit 305, the PAs 306 and 307, the LNAs 308 and 309, and the switches 310 and 311, the invention is not limited to such a configuration. For example, as shown in FIG. 9, the Mini PCI card 24 may incorporates the radio circuit 305, the PAs 306 and 307, the LNAs 308 and 309, the switches 310 and 311, the power control circuit 315, and the switch 316. Whereas in the former configuration the Mini PCI card 24 can be increased in general versatility, in the latter configuration the notebook PC 10 (excluding the Mini PCI card 24) can be increased in general versatility. Even in the configuration of FIG. 9, the process relating to the determination of a communication method and other features are the same as in the configuration of FIG. 3 and hence will not be described.

What is claimed is:

1. A wireless communication apparatus comprising:
a plurality of transmitting/receiving sections which cooperate with each other to perform a wireless communication by the same communication method;
a power supplying section which supplies power to the plurality of transmitting/receiving sections; and
a switching section which switches between a mode in which only part of the plurality of transmitting/receiving sections is supplied with power from the power supplying section and the wireless communication is performed by the part of the plurality of transmitting/receiving sections and another mode depending on whether a prescribed condition is satisfied.

2. The wireless communication apparatus according to claim 1, wherein the switching section switches between the mode in which only the part of the plurality of transmitting/receiving sections is supplied with power and a mode in which all of the plurality of transmitting/receiving sections are supplied with power in accordance with a type of a source that is supplying power to the power supplying section.

3. The wireless communication apparatus according to claim 1, wherein the switching section causes the power supplying section to supply power to only the part of the plurality of transmitting/receiving sections when a battery supplies power to the power supplying section.

4. The wireless communication apparatus according to claim 1, further comprising a remaining life calculating section which checks a remaining life of a battery that is supplying power to the power supplying section;
wherein the switching section causes the power supplying section to supply power to only the part of the plurality of transmitting/receiving sections when the remaining life checked by the remaining life calculating section is shorter than a prescribed value.

5. The wireless communication apparatus according to claim 1, wherein the switching section causes the power supplying section to supply power to all of the plurality of transmitting/receiving sections when an amount of data to be transmitted or received by the transmitting/receiving section is larger than or equal to a prescribed value.

6. The wireless communication apparatus according to claim 1, further comprising an apparatus type judging section which judges an apparatus type of a radio apparatus to communicate with the transmitting/receiving section;
wherein the switching section switches between the mode in which only the part of the plurality of transmitting/receiving sections is supplied with power and a mode in which all of the plurality of transmitting/receiving sections are supplied with power in accordance with the apparatus type of the radio apparatus judged by the apparatus type judging section.

7. A wireless communication board comprising:
a plurality of transmitting/receiving sections which cooperate with each other to perform a wireless communication by the same communication method; and
a switching section which switches between a mode in which only part of the plurality of transmitting/receiving sections is supplied with power and the wireless communication is performed by the part of the plurality of transmitting/receiving sections and a mode in which all of the plurality of transmitting/receiving sections is supplied with power and the wireless communication is performed by all of the plurality of transmitting/receiving sections.
